(19) United States
(12) Patent Application Publication
(10) Pub. No.: US 2010/0161547 A1
(43) Pub. Date: Jun. 24, 2010

(54) Personalized Web Feed Views

(76) Inventors: David Carmel, Haifa (IL); Haggai Roitman, Qiryat-Ata (IL)

Correspondence Address: IBM CORPORATION, T.J. WATSON RESEARCH CENTER, P.O. BOX 218, YORKTOWN HEIGHTS, NY, 10598, US

(21) Appl. No.: 12/342,090

(22) Filed: Dec. 23, 2008

(51) Int. Cl. G06N 5/02; G06F 7/06; G06F 17/30; G06F 3/048

(52) U.S. Cl. 706/59; 715/810; 715/833; 715/808; 715/760; 707/E17.016; 707/E17.109

(57) ABSTRACT

A system for generation of personalized Web feed views in accordance with pre-defined profile parameters, is presented. The system including a user definition interface for receiving at least one user parameter and sending the parameter to a content provider and a feed view personalization unit operable to receive the user parameter and customize feed content in accordance with the at least one user parameter for displaying to the user.

### FIELD OF THE INVENTION

The present invention relates to content management in general, and more particularly to personalized Web feed views based on a user's pre-defined profile parameters.

### BACKGROUND OF THE INVENTION

The usage of web feeds for the dissemination of summarized content is continuously expanding, and nowadays a majority of new published content on the web is available also in the form of a Web feed.

Content providers use web feeds as convenient means for summarizing the content available on their websites, where Web feeds are used as an efficient way to allow remote clients (e.g., web readers) to consume such summaries and discover feed items that link to content that may be of interest to potential users.

Known applications used for reading feeds on the client's side (hereinafter referred to as “feed reader applications”) allow some level of personalization of the feed content read by their users, i.e., filtering irrelevant items, or ordering the items according to some criterion (e.g., item's recentness). However, such personalization on a feed reader's side only is not enough, and additional personalization is also required on the feed provider side. For example, a reader who consumes content from a website still has to filter irrelevant items that do not fit the user's profile. Furthermore, readers have no way to control the template that is used to generate the content of the feeds (hereinafter referred to as “feed view”) supplied by feed providers (for example a feed view might specify that each item is provided as a title without an associated description. There is presently no way for a reader to influence the feed view such as to require the inclusion of a description with a feed item to improve the suitability of the feed for the user)

Low feed suitability for users may cause users to unsubscribe from content providers that might have been relevant for their use but could not be determined as such, due to the lack of additional personalization by the content providers themselves. Currently, content providers provide feeds that are classified in a very simple way according to some topic (e.g., CNN-news, CNN-politics, CNN-entertainment). They do not provide means by which users can access their content according their specific needs. Such means are provided by the present invention.

### SUMMARY OF THE INVENTION

The present invention in embodiments thereof discloses novel system and method for generation of personalized web feed views in accordance with pre-defined profile parameters.

In one aspect of the present invention a system is provided for generation of personalized Web feed views in accordance with pre-defined profile parameters, the system including a user definition interface for receiving at least one user parameter and sending the parameter to a content provider and a feed view personalization unit operable to receive the user parameter and customize feed content in accordance with the at least one user parameter for displaying to the user.

Preferably, the user definition interface is operative to present at least two different icons, corresponding to at least two possible user's profile parameters.

Preferably, the user definition interface is operative to present to the user a slider for selection among different levels of the parameters.

Preferably, the slider is presented in response to mouse device clicking.

Preferably, the slider is presented in response to mouse device hovering over an icon.

Preferably, the user definition interface is operative to present popup dialog window, configured to spread one or more parameters to the user.

Preferably, the popup dialog window is presented in response to mouse device clicking.

Preferably, the pop up dialog window is presented in response to mouse device hovering.

Preferably, the feed view personalization unit includes a definition to rules mapper unit, operative to receive one or more parameters and map them to one or more new or previously generated rules, a rules base, operative to store the rules, a personalized feed view generator, configured to receive the rules and an updated version of a web feed content and create a personalized feed view, a feed content database, operative to store the updated version of web feed content, and a feed URL rewriter, configured to adjust an original feed URL to reflect the created personalized feed view content and avoid the need to re-map the applied rules to future contents delivered to the user.

In another aspect of the present invention a method for generation of personalized Web feed views in accordance with pre-defined profile parameters is provided. The method includes the steps of displaying a user interface for enabling selecting of one or more profile parameters, sending the parameters and a predefined feed URL, customizing a feed content according to the parameters for creating a personalized feed view, and displaying the personalized feed view.

Preferably, the displaying step includes presentation of at least two different icons, corresponding to at least two possible user profile parameters.

Preferably, the displaying step includes presentation of a slider for selection among different levels of the parameters.

Preferably, the step of slider presentation occurs in response to a mouse device clicking.

Preferably, the step of slider presentation occurs in response to a mouse device hovering.

Preferably, the displaying step includes presentation of a popup dialog window, for spreading one or more parameters to the user.

Preferably, the step of popup dialog window presentation occurs in response to a mouse device clicking.

Preferably, the step of popup dialog window presentation occurs in response to a mouse device hovering.

In another aspect of the present invention a computer-implemented program for generation of personalized Web feed views in accordance with pre-defined profile parameters embodied on a computer-readable medium is provided. The computer program includes a code segment operative to display a user interface for enabling selecting of one or more profile parameters, a code segment operative to send the parameters and a predefined feed URL, a code segment operative to customize a feed content to according to the parameters for creating a personalized feed view, and a code segment operative to display the personalized feed view.

### BRIEF DESCRIPTION OF THE DRAWINGS

The present invention will be understood and appreciated more fully from the following detailed description taken in conjunction with the appended drawings in which:

FIG. 1 illustrates an exemplary computing environment in accordance with one or more embodiments of the present invention.

FIG. 2 is a simplified conceptual illustration of a system for efficient generation of personalized web feed views in accordance with pre-defined profile parameters, constructed and operative in accordance with an embodiment of the present invention;

FIG. 3a-3c pictorially illustrate user interface alternatives for the system of FIG. 2, in accordance with various embodiments of the present invention;

FIG. 4 is a simplified flowchart illustration of an exemplary method of operation of the system of FIG. 2, operative in accordance with an embodiment of the present invention; and

FIG. 5 is a simplified block diagram illustration of an exemplary hardware implementation of a computing system, constructed and operative in accordance with an embodiment of the present invention.

### DETAILED DESCRIPTION OF THE INVENTION

The present invention in embodiments thereof discloses novel system and method for generation of personalized web feed views in accordance with pre-defined profile parameters.

The present invention is now described within the context of one or more embodiments, although the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

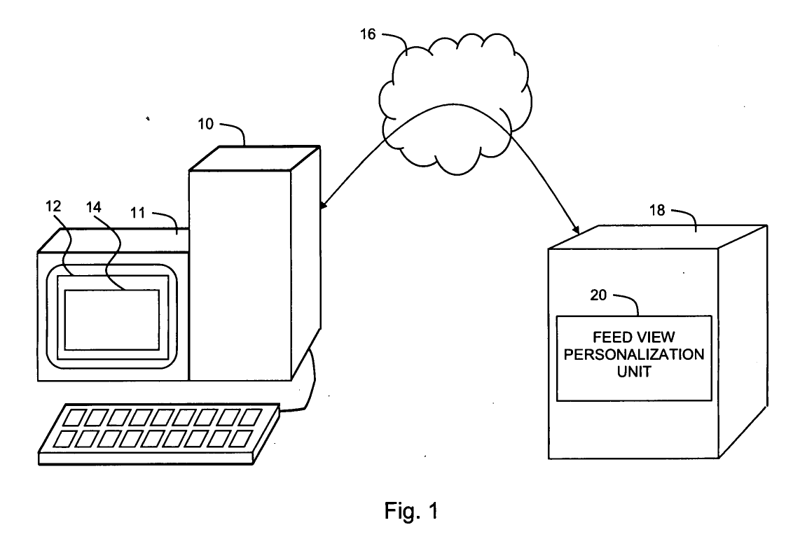

Reference is now made to FIG. 1, which illustrates an exemplary computing environment in accordance with one or more embodiments of the present invention. Client computer 10 may be coupled to network 16 and may run a web browser 12, which may be adapted to present content 14 of a web page on display 11. Client computer 12 is connected to server computer 18 via network 16. Server computer 18 hosts and operates a Feed View Personalization Unit 20 that is configured to generate personalized web feed views in accordance with pre-defined profile parameters, as described in detail hereinafter.

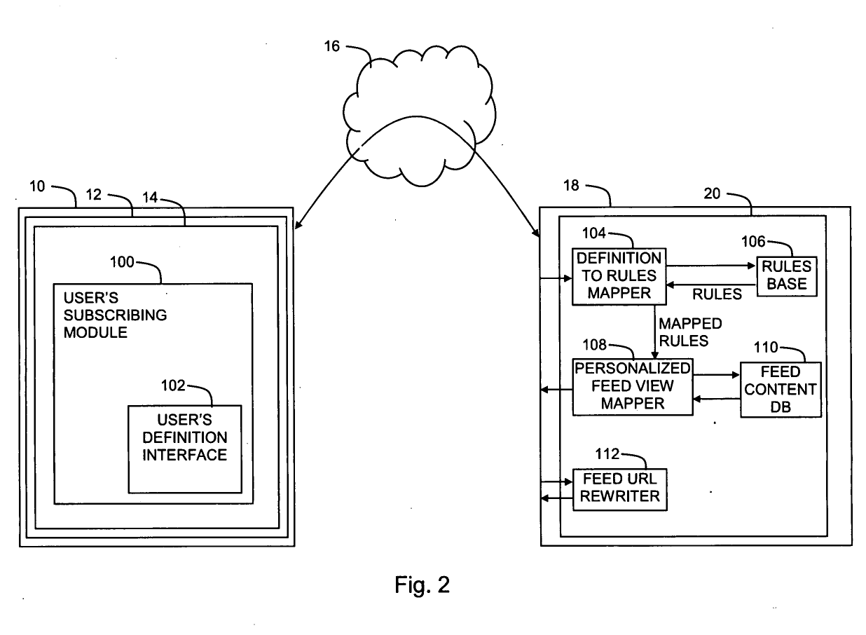

Reference is now made to FIG. 2, which is a simplified conceptual illustration of a system for efficient generation of personalized web feed views in accordance with pre-defined profile parameters, constructed and operative in accordance with an embodiment of the present invention.

Client computer 10 runs web browser 12 that may present a content web page 14 to a user of computer 10. Page 14 may offer the user an option to subscribe to a service of receiving personalized web feed views, using user subscribing module 100, which comprises a user definition interface 102. Both will be broadly referred to hereinafter.

As explained above, computer 10 is coupled to network 16. In an embodiment of the present invention, network 16 may be the Internet, which represents a worldwide collection of networks and gateways that use the Transmission Control Protocol/Internet Protocol (TCP/IP) suite of protocols to communicate with one another.

User Subscribing Module 100 is configured to enable a user to subscribe to, and receive feed views from a certain content provider and to define his profile (comprised of one or more relevant parameters) before consuming the content (using its feed reader application). As described above, user definitions received by module 102 are transferred via network 16 to personalization unit 20. The personalization unit processes the definitions together with a URL for the relevant feed to create personalized feed views. In one alternative embodiment, the personalized feed views are subsequently delivered to the user.

In accordance with an embodiment of the present invention, server computer 18 hosts and runs Feed View Personalization Unit 20. Unit 20 typically comprises Definition to Rules Mapper unit 104 operative to receive user's defined parameters and map them to one or more new rules, or to one or more previously generated rules, stored in Rules Base 106. Unit 20 further comprises Personalized Feed View Generator 108, Feed Content Database 110 and Feed URL rewriter 112. Generator 108 may receive the mapped rules from mapper 104. Generator 108 may also receive an updated version of the web feed content from Database 110. Generator 108 then creates the personalized feed view, using techniques known in the art for customization of feed content. The personalized feed view may be later sent via network 16 to client computer 10. Rewriter 112 may be configured to modify the original feed URL, adjusting the URL to reflect recently created personalized feed view content, to avoid the need to re-map same applied rules to future content delivered to same user.

User Definition interface 102 is configured to allow definition of preferences by selecting icons and reacting to pop-ups, in accordance with various embodiments of the present invention.

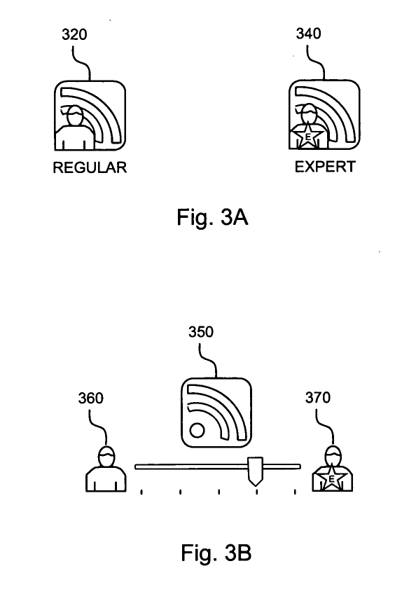

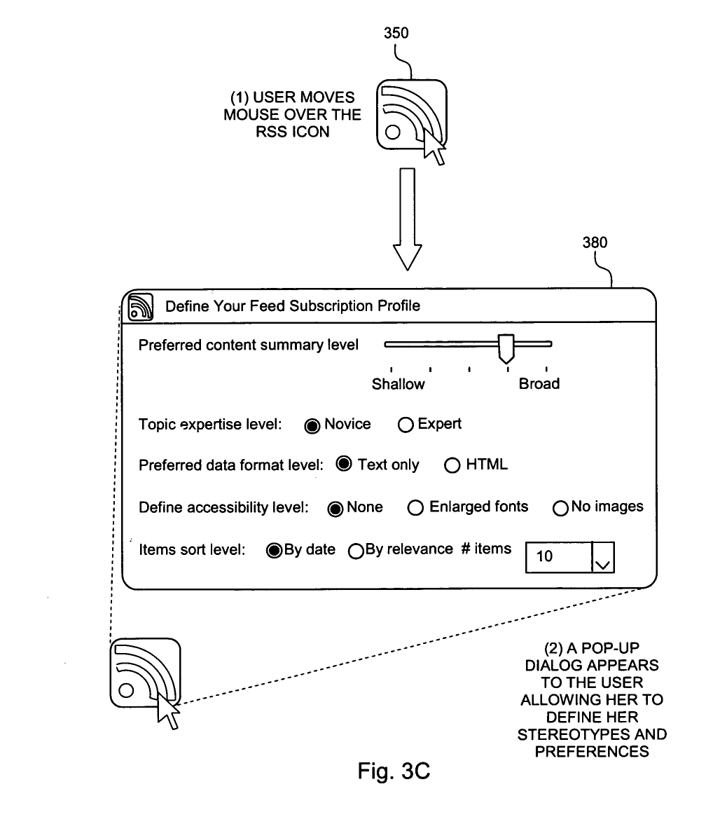

Reference is now made to FIG. 3a, which pictorially illustrates an alternative to user interface 102 for the system of FIG. 2, in accordance with one embodiment of the present invention. The interface illustrated in FIG. 3a is based on associating a designated icon to each of the possible feed views among which the subscribing user may select. For the purpose of simplification and exemplification, it is assumed that the only considered parameter for the personalization of a consumed feed content is the level of expertise that a subscribing user has in the field in which he is intend to receive feed views from a certain content provider. However, this does not limit the present invention to the above parameter. Other parameters may be considered, additionally or severally to the above parameter. As shown in FIG. 3a, two icons are displayed to the user. Icon 320 is presented for the definition of the regular user, who may be satisfied with an ordinary level of content to be delivered by the provider, and the second icon 340 is presented for the definition of a user who considers himself as an expert and who may prefer to receive content of a different level of detail from the same content provider. In this embodiment, any selection of one of the presented icons links to a different feed view, depending on the parameters incorporated behind the clicked icon. While the embodiment describes a selection among two options, it is clear to those skilled in the art, that there may be numerous options for selection for each parameter. For the above example, a “novice” level may represent a third level of expertise, in addition to the above mentioned “regular” and “expert” levels.

Reference is now made to FIG. 3b, which pictorially illustrates another alternative to user interface 102 for the system of FIG. 2, in accordance with one embodiment of the present invention. The described interface enables selecting among several options. In reference to the illustrative example, the selection is not limited to only pre-defined number options as suggested by the embodiment presented in FIG. 3a above, but may choose between various and selection sensitive levels of expertise. Whenever the mouse device clicks on or hovers Feed Icon 350, this icon 350 is modified and a Slider Feed Icon 340 is presented to the user. Hence, the number of feed views available for definition is similar to the number of intervals on the slider. The slider bar may be bounded by 2 icons 350 and 360, while additional icons may be also displayed to mark intermediate levels for definition by the user.

Reference is now made to FIG. 3c, which pictorially illustrates another alternative to user interface 102 for the system of FIG. 2, in accordance with yet another embodiment of the present invention. As illustratively shown, following mouse clicking on or hovering feed icon 350, a popup window 380 is displayed, allowing the definition of profile and preferences parameters. In the present embodiment the popup window allows definition of the preferred level of content summary (“shallow” would return a feed that contains items with titles only, while “broad” would return items that contain detailed summaries in the item descriptions). The level of expertise may be defined as per the feed topic (e.g., novice or expert). Alternatively, the data formatting level of the feed content (e.g., either plain text or embedded html), may be selected or any special accessibility requirements (enlarged fonts or no image support). Finally for the presented embodiment, popup 380 may allow selection of the maximum number of items that should be provided on the feed content and the type of sorting for items. Given that a feed content provider can support delivering of feed view level X, this embodiment may provide means for the user to define his preferences to feature X during subscription to the feed.

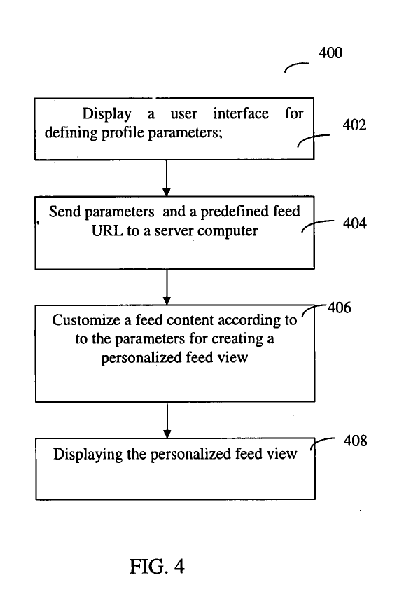

Reference is now made to FIG. 4, which is a simplified flowchart illustration of an exemplary method of operation of the system of FIG. 2, operative in accordance with an embodiment of the present invention.

In method 400 of FIG. 4 a user interface is first presented (402) to a user in response to a mouse click or a mouse hovering an icon displayed in a webpage run and operated by a feed content provider. A definition of the user profile and preferences parameters is recorded and sent (404) via network, together with a predefined feed URL to a server computer. At step 406, the received defined parameters and feed URL are processed at the server computer by Feed View Personalization Unit 20, and the feed content is customized according to the user defined parameters. Then (408), the personalized feed view is displayed to the subscribed user using network 16.

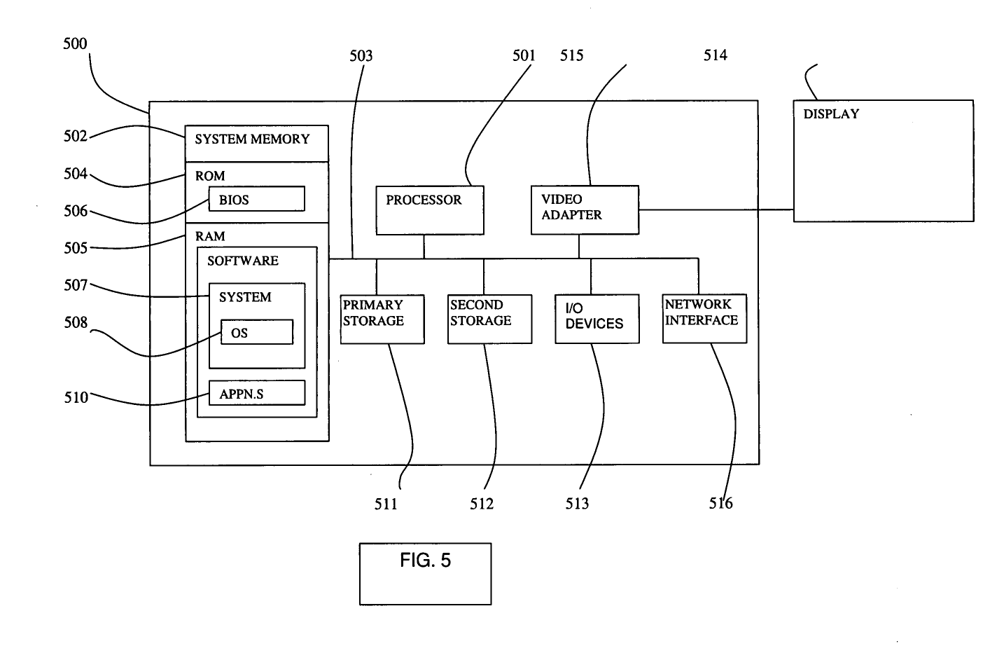

Reference is now made to FIG. 5, which is a simplified block diagram illustration of an exemplary hardware implementation of a computing system, constructed and operative in accordance with an embodiment of the present invention. Such system includes a data processing system 500 suitable for storing and/or executing program code, and including at least one processor 501 coupled directly or indirectly to memory elements through a bus system 503. The memory elements can include local memory employed during actual execution of the program code, bulk storage, and cache memories, which provide temporary storage of at least some program code in order to reduce the number of times code must be retrieved from bulk storage during execution.

The memory elements may include system memory 502 in the form of read only memory (ROM) 504 and random access memory (RAM) 505. A basic input/output system (BIOS) 506 may be stored in ROM 504. System software 507 may be stored in RAM 505 including operating system software 708. Software applications 710 may also be stored in RAM 505.

The system 500 may also include a primary storage means 511, such as a magnetic hard disk drive and secondary storage means 512, such as a magnetic disk drive and an optical disc drive. The drives and their associated computer-readable media provide non-volatile storage of computer-executable instructions, data structures, program modules and other data for the system 500. Software applications may be stored on the primary and secondary storage means 511, 512 as well as the system memory 502.

The computing system 500 may operate in a networked environment using logical connections to one or more remote computers via a network adapter 516.

Input/output devices 513 can be coupled to the system either directly or through intervening I/O controllers. A user may enter commands and information into e system 500 through an input device such as a keyboard, pointing device, or other input device (for example, microphone, joy stick, game pad, satellite dish, scanner, or the like). Output devices may include speakers, printers, etc. A display device 514 is also connected to system bus 503 via an interface, such as video adapter 515.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects, any of which may generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the methods and apparatus herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for generation of personalized Web feed views in accordance with pre-defined profile parameters, comprising:
a user definition interface for receiving at least one user parameter and sending the parameter to a content provider; and
a feed view personalization unit operable to receive the user parameter and customize feed content in accordance with the at least one user parameter for displaying to the user.

2. A system according to claim 1 wherein the user definition interface is operative to present at least two different icons, corresponding to at least two possible user's profile parameters definitions.

3. A system according to claim 1 wherein the user definition interface is operative to present to the user a slider for selection among different levels of the parameters.

4. A system according to claim 3 wherein the slider is presented in response to mouse device clicking.

5. A system according to claim 3 wherein the slider is presented in response to mouse device hovering.

6. A system according to claim 1 wherein the user definition interface is operative to present popup dialog window, configured to display one or more parameters to the user.

7. A system according to claim 6 wherein the popup dialog window is presented in response to mouse device clicking.

8. A system according to claim 6 wherein the pop up dialog window is presented in response to mouse device hovering over an icon.

9. A system according to claim 1 wherein the feed view personalization unit comprises:
a definition to rules mapper unit operative to receive the one or more parameters and map them to one or more new or previously generated rules;
a rules base, operative to store the rules;
a personalized feed view generator, configured to receive the rules and an updated version of a web feed content and create a personalized feed view;
a feed content database, operative to store the updated version of web feed content; and
a feed URL rewriter, configured to adjust an original feed URL to reflect the created personalized feed view content and avoid the need to re-map the applied rules to future contents delivered to the user.

10. A method for generation of personalized Web feed views in accordance with pre-defined profile parameters, comprising the steps of:
displaying a user interface for enabling selecting of one or more profile parameters;
sending the parameters and a predefined feed URL;
customizing a feed content according to the parameters for creating a personalized feed view; and
displaying the personalized feed view.

11. A method according to claim 10 wherein the displaying step comprises presentation of at least two different icons, corresponding to at least two possible user profile parameters.

12. A method according to claim 10 wherein the displaying step comprises presentation of a slider for selection among different levels of the parameters.

13. A method according to claim 12 wherein the step of slider presentation occurs in response to a mouse device clicking.

14. A method according to claim 12 wherein the step of slider presentation occurs in response to a mouse device hovering.

15. A method according to claim 10 wherein the displaying step comprises presentation of a popup dialog window, for displaying one or more parameters to the user.

16. A method according to claim 15 wherein the step of popup dialog window presentation occurs in response to a mouse device clicking.

17. A method according to claim 15 wherein the step of popup dialog window presentation occurs in response to a mouse device hovering.

18. A computer-implemented program for generation of personalized Web feed views in accordance with pre-defined profile parameters embodied on a computer-readable medium, the computer program comprising:
a code segment operative to display a user interface for enabling selecting of one or more profile parameters;
a code segment operative to send the parameters and a predefined feed URL;
a code segment operative to customize a feed content to according to the parameters for creating a personalized feed view; and
a code segment operative to display the personalized feed view.

19. A program according to claim 18 wherein the code segment operative to display further operative to present at least two different icons, corresponding to at least two possible user profile parameters.

20. A program according to claim 18 wherein the code segment operative to display further operative to present a slider for selection among different levels of the parameters.

21. A program according to claim 20 wherein the slider's presentation occurs in response to a mouse device clicking.

22. A program according to claim 20 wherein the slider's presentation occurs in response to a mouse device hovering.

23. A program according to claim 18 wherein the code segment operative to display further operative to present a popup dialog window, for displaying one or more parameters to the user.

24. A program according to claim 23 wherein the presentation of popup dialog window occurs in response to a mouse device clicking.

25. A program according to claim 23 wherein the presentation of popup dialog window occurs in response to a mouse device hovering.
